(19) United States
(12) Patent Application Publication
(10) Pub. No.: US 2006/0045186 A1
(43) Pub. Date: Mar. 2, 2006

(54) Apparatus and method for coding moving picture

(75) Inventors: Shinichiro Koto, Tokyo (JP); Wataru Asano, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/211,720

(22) Filed: Aug. 26, 2005

(30) Foreign Application Priority Data
Sep. 2, 2004 (JP) 2004-255810

(51) Int. Cl. H04N 11/02; H04N 7/12; H04N 11/04; H04B 1/66

(52) U.S. Cl. 375/240.16; 375/240.24; 375/240.12

(57) ABSTRACT

An apparatus for coding a moving picture includes a motion vector generating unit that generates a motion vector based on a first predicted motion vector stored; and a coding information generating unit that generates coding information used to code a target block, based on the motion vector generated by the motion vector generating unit. The apparatus also includes a second predicted motion vector generating unit that generates a second predicted motion vector for the target block; and a coding unit that codes an image of the target block based on the second predicted motion vector.

### CROSS-REFERENCE TO RELATED APPLICATIONS

This application is based upon and claims the benefit of priority from the priority Japanese Patent Application No. 2004-255810, filed on Sep. 2, 2004; the entire contents of which are incorporated herein by reference.

### BACKGROUND OF THE INVENTION

1. Field of the Invention

The present invention relates to a moving picture coding apparatus, a moving picture coding method, and computer program product, which perform a coding process to a moving picture.

2. Description of the Related Art

In motion-compensated predictive inter-frame image coding for moving pictures, accuracy of motion vector estimation in coding considerably affects coding efficiency. An amount of process of the motion vector estimation accounts for a large share of the entire coding process. A large number of conventional techniques related to the increases in accuracy and speed of the motion vector estimation are developed (for example, see Algorithms, Complexity Analysis and VLSI-Architectures for MPEG-4 motion Estimation”, Chapter 5, Peter Kuhn, Kluwer Academic Publishers (1999)). The motion vector estimation is performed by a block matching method such that a reference pixel block having the minimum prediction residual is determined in reference frames by a matching method.

However, there is an overhead when a motion vector itself is coded. For this reason, on the relationship between a coding rate and a coding distortion, an optimum motion vector cannot be determined by only the size of the prediction residual. For this reason, there is provided a method of determining an optimum motion vector based on a linear combination of the amount of the prediction residuals and a coding cost of a motion vector (for example, see Japanese Patent Application Laid-Open No. 2003-230149).

In international standards such as ITU-T Rec. H.264 (hereinafter, referred to as H.264) of moving picture coding, when a motion vector is to be coded, a predicted vector is calculated from motion vectors of a plurality of pixel blocks, which have been coded in the same frame. A difference between the predicted vector and a motion vector to be coded is coded.

In H.264, each macroblock can be divided into various motion-copensated prediction block shapes, and motion vectors are coded in respective divided pixel blocks.

An arbitrary reference frame is selected from a plurality of reference frames in each pixel block to make it possible to generate a prediction signal. An index representing the selected reference frame is also coded as needed.

In addition, coding can also be performed in each macroblock by inter-frame coding or intra-frame coding. Prediction vectors in H.264 are calculated depending on prediction block divided shapes in a plurality of peripheral coded pixel blocks, motion vectors of pixel blocks and indexes of reference frame selection, and intra-frame coding and inter-frame coding (to be generally referred to as coding modes hereinafter). Therefore, in order to calculate the coding costs of the motion vectors, determined coding mode information is necessary in the plurality of peripheral pixel blocks.

However, motion vectors and coding mode information in a block to be processed are information to which a coding process in the block must be performed. Therefore, until the coding process in the peripheral blocks is completed, accurate predicted vectors and weighting factors of motion vector coding costs cannot be determined.

### SUMMARY OF THE INVENTION

According to one aspect of the present invention, apparatus for coding a moving picture includes a first predicted motion vector storing unit that stores a predetermined first predicted motion vector; a motion vector generating unit that generates a motion vector based on the first predicted motion vector; a coding information generating unit that generates coding information used to code a target block, based on the motion vector generated by the motion vector generating unit; a second predicted motion vector generating unit that generates a second predicted motion vector for the target block; and a coding unit that codes an image of the target block based on the second predicted motion vector.

According to another aspect of the present invention, an apparatus for coding a moving picture includes a motion vector generating unit that generates a motion vector of a first region to be coded based on quantization parameter which has been generated for a second region having an image adjacent to an image of the first region; and a coding unit that codes the image of the first region based on the motion vector.

According to still another aspect of the present invention, a method for coding a moving picture includes generating a motion vector based on a first predicted motion vector; generating coding information used to code a target block, based on the motion vector; generating a second predicted motion vector for the target block; and coding an image of the target block based on the second predicted motion vector.

According to still another aspect of the present invention, a method for coding a moving picture includes generating a motion vector of a first region to be coded based on quantization parameter which has been generated for a second region having an image adjacent to an image of the first region; and coding the image of the first region based on the motion vector.

A computer program product according to still another aspect of the present invention causes a computer to perform the method according to the present invention.

### BRIEF DESCRIPTION OF THE DRAWINGS

FIG. 1 is a block diagram of a configuration of a moving picture coding apparatus according to a first embodiment;

FIG. 2 is a block diagram of a detailed functional configuration of a motion vector estimating unit explained in FIG. 1;

FIG. 3A is a diagram for explaining motion vector prediction, and FIG. 3B is a diagram for explaining motion vector prediction;

FIG. 4 is a flow chart of a moving picture coding process in the moving picture coding apparatus;

FIG. 5 is a flow chart of detailed processes of the motion vector estimating unit and a first prediction motion vector calculating unit in the motion vector estimating process shown in FIG. 4;

FIG. 6 is a flow chart of detailed processes of an entropy coding unit and a second prediction motion vector calculating unit in an entropy coding process explained in FIG. 4.

FIG. 7 is a diagram showing an order of a moving picture coding process in the moving picture coding apparatus according to the embodiment;

FIG. 8 is a diagram showing a hardware configuration of the moving picture coding apparatus according to the embodiment;

FIG. 9 is a chart showing an order and timings of processes in the moving picture coding apparatus according to a second embodiment;

FIG. 10 is a chart showing an order and timings of processes according to a third embodiment;

FIG. 11 is a chart of an order and timings of coding processes of the moving picture coding apparatus according to a fourth embodiment; and

FIG. 12 is a chart showing an example of a timing chart of motion vector estimation in telescopic searching.

### DETAILED DESCRIPTION OF THE PREFERRED EMBODIMENTS

Embodiments of a moving picture coding apparatus, a moving picture coding method, and a moving picture coding program according to the present invention will be described in detail with reference to the accompanying drawings. The invention is not limited to the embodiments.

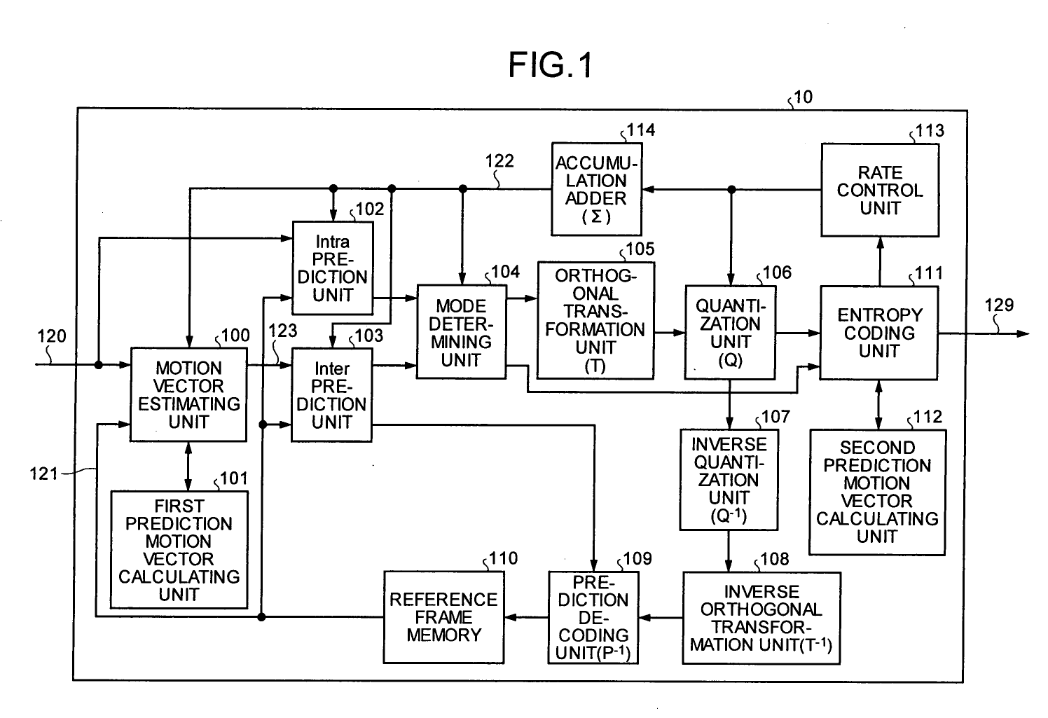

FIG. 1 is a block diagram showing a configuration of a moving picture coding apparatus according to a first embodiment of the present invention. The moving picture coding apparatus 10 includes a motion vector estimating unit 100, a first prediction motion vector calculating unit 101, an Intra prediction unit 102, an Inter prediction unit 103, a mode determining unit 104, an orthogonal transformation unit (T) 105, a quantization (Q) unit 106, an inverse quantization unit (Q⁻¹) 107, an inverse orthogonal transformation unit (T⁻¹) 108, a prediction decoding unit (P⁻¹) 109, a reference frame memory 110, an entropy coding unit 111, and a second prediction motion vector calculating unit 112.

An input moving picture signal 120 is input to the motion vector estimating unit 100. The motion vector estimating unit 100 reads a reference image signal 121 stored in the reference frame memory 110 for each macroblock. Optimum motion compensation parameters are determined. In this case, the motion compensation parameters are information related to selection of motion vectors, shapes of motion compensation prediction blocks, and reference frames.

The first prediction motion vector calculating unit 101 calculates a first prediction motion vector serving as a virtual prediction motion vector. The first prediction motion vector calculating unit 101 calculates a difference between the calculated first prediction motion vector and an actual motion vector. From the calculated difference, an approximate coding cost of a motion vector is calculated. The calculated approximate coding cost is used in order to determine the optimum motion compensation parameter. The details of the motion vector estimating unit 100 will be described later.

Once the optimum motion compensation parameter is determined by the motion vector estimating unit 100, the Inter prediction unit 103 performs a motion compensation process. In the motion compensation process, a motion (for example, a ½-pixel accuracy or ¼-pixel accuracy) smaller than one pixel is estimated. An inter-frame amplitude compensation process is performed by multiplication of a weighting factor, addition of an offset, and the like. Thereafter, prediction residual signals are generated for a luminance signal and a color difference signal, respectively.

The input moving picture signal 120 is also input to the Intra prediction unit 102. The Intra prediction unit 103 reads the local decoded image signal 121 in a coded region in a current frame stored in the reference frame memory 110. An intra-frame prediction process is performed based on a read local decoded image.

The mode determining unit 104 inputs a candidate of at least one Inter prediction and a candidate of at least one Intra prediction. Costs of the candidates are calculated to determine an optimum coding mode.

The orthogonal transformation unit 105 performs an orthogonal transformation to a prediction residual signal. The orthogonal transformation is performed in a coding mode determined by the mode determining unit 104. The quantization unit 106 quantizes an orthogonal transformation coefficient obtained after orthogonal transformation.

The second prediction motion vector calculating unit 112 calculates a second prediction motion vector independently of the first prediction motion vector calculating unit 101. The second prediction motion vector calculating unit 112 calculates a difference between the calculated second prediction motion vector and a motion vector to be coded. The calculated difference is coded by the entropy coding unit 111.

The entropy coding unit 111 performs entropy coding such as variable-length coding or arithmetic coding to the quantized orthogonal transformation coefficient.

Coded data 129 is output from the entropy coding unit 111. Coding mode information such as a motion vector is also coded by the entropy coding unit 111. The mode coded information is output from the entropy coding unit 111 together with the coded orthogonal transformation coefficient.

The orthogonal transformation coefficient quantized by the quantization unit 106 is subjected by a local decoding process in the inverse quantization unit 107, the inverse orthogonal transformation unit 108, and the prediction decoding unit 109. The resultant image is stored as a reference image in the reference frame memory 110.

Code amount information generated by the entropy coding unit 111 in a macroblock unit is input to a rate control unit 113. The rate control unit 113 performs rate control by feedback control based on the input code amount information. The rate control unit 113 determines a quantization parameter (QP) in a macroblock (MB) unit. The quantization parameter QP is input to the quantization unit 106 and also input to an accumulation adder 114.

The accumulation adder 114 accumulates and adds quantization parameters QP in units of predetermined periods to calculate an average value in each predetermined period. A calculated average quantization parameter 122 is input to the motion vector estimating unit 100, the Intra prediction unit 102, the Inter prediction unit 103, and the mode determining unit 104. The average quantization parameter 122 is used to determine an optimum coding parameter and a coding mode.

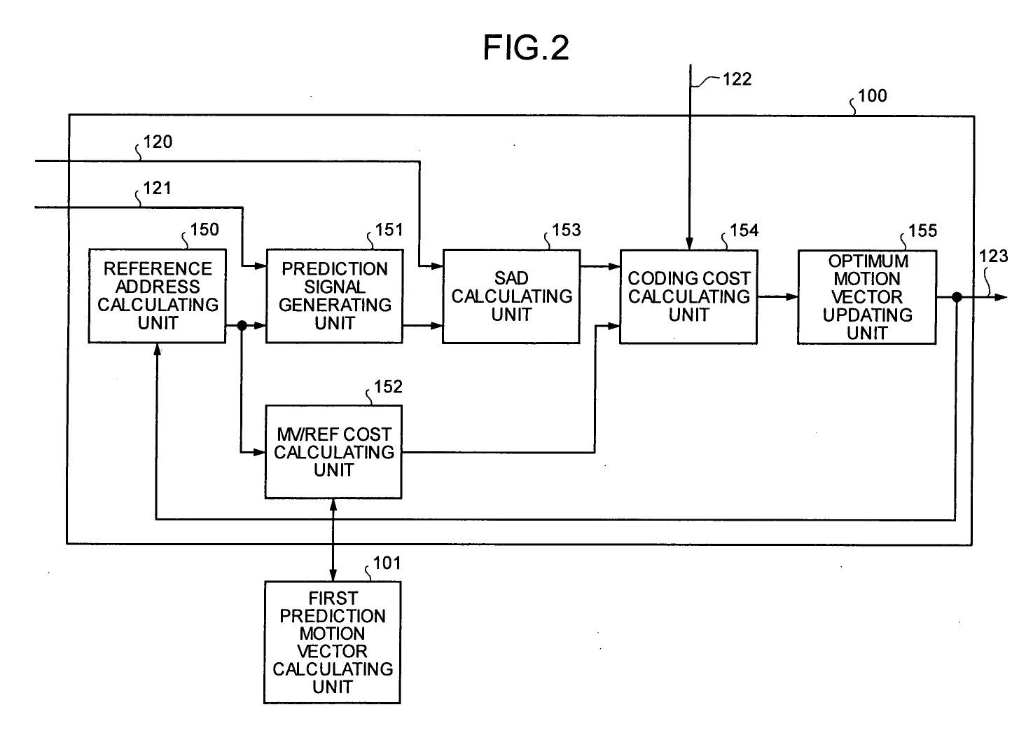

FIG. 2 is a block diagram showing a detailed functional configuration of the motion vector estimating unit 100 explained in FIG. 1. The motion vector estimating unit 100 has a reference address calculating unit 150, a prediction signal generating unit 151, a coding cost calculating unit 152 for a motion vector (MV) and reference frame identification information (REF), an SAD calculating unit 153, a coding cost calculating unit 154, and an optimum motion vector updating unit 155.

In the motion vector estimating unit 100, the reference address calculating unit 150 determines a center and a searching range of motion vector searching for each macroblock. An appropriate reference frame is also selected. On the basis of the determined searching center, the determined searching range, and the selected reference frame, an address of a reference pixel block is calculated. The reference address calculating unit 150 outputs the address information of the reference pixel block and a motion vector corresponding to the address information.

The prediction signal generating unit 151 reads the reference image signal 121 from the reference frame memory 110 according to the address information calculated by the reference address calculating unit 150. The prediction signal generating unit 151 generates a prediction pixel block signal. The SAD calculating unit 153 calculates a sum of absolute difference (SAD) between the generated prediction pixel block signal and an input pixel block signal to be coded.

On the other hand, the MV/REF cost calculating unit 152 calculates a cost (MV cost) to code a difference between the first prediction motion vector calculated by the first prediction motion vector calculating unit 101 and the motion vector calculated by the reference address calculating unit 150. The MV/REF cost calculating unit 152 calculates a cost (REF cost) to code information for identifying a reference frame. The MV cost corresponds to an amount of code obtained when the difference between the vectors to be identified is subjected to variable-length coding. The REF cost corresponds to an amount of code when reference frame identification information is subjected to variable-length coding.

The coding cost calculating unit 154 calculates a coding cost expressed by (Equation 1) based on the SAD calculated by the SAD calculating unit 153 and the MV cost and the REF cost calculated by the MV/REF cost calculating unit 152. In this case, the coding cost is calculated as a linear sum between the SAD, the MV cost, and the REF cost.

In Equation (1), reference symbol λ denotes a weighting factor of the linear sum. The weighting factor λ is determined by the quantization parameter QP as shown in Equation (2). As the quantization parameter QP, the average quantization parameter 122 calculated by the accumulation adder 114 in an immediately previous predetermined unit is used. As the average quantization parameter, for example, an average QP or the like in a immediately previous coded frame is used.
coding cos t=SAD+λ·(MV cos t+REF cos t) (1)
λ=\sqrt{0.85·2^{(QP-12)/3}} (2)

In this manner, the motion vector and the MV/REF cost calculating unit 152 according to the embodiment uses quantization parameters of coded macroblocks without using the quantization parameters QP of the current macroblocks in coding cost calculation in motion estimation represented by Equations (1) and (2).

In general, the quantization parameter QP moderately varies due to rate control. The frequency of sharply and considerably varying the quantization parameter QP within a short period of time is low. For this reason, even though a coding cost is calculated by using the quantization parameter QP of the immediately previous coded image and an average value in the short period of time, a calculation accuracy of the coding cost dose not decrease.

Furthermore, Motion vector estimation can be performed before rate control process to determine the quantization parameter QP of the current macroblock is completed. A high degree of freedom can be given to a coding process order while suppressing coding efficiency from being deteriorated. Independently of restriction of the coding process order, an optimum motion vector can be always estimated.

The optimum motion vector updating unit 155 stores a motion vector having the minimum cost calculated as described above. A reference frame number and the like used at this time are also stored. These processes are repeated while switching reference pixel blocks for the respective macroblocks, and motion compensation parameters 123 including one optimum motion vector or a plurality of optimum motion vectors, an optimum reference frame number, and the like are determined and output.

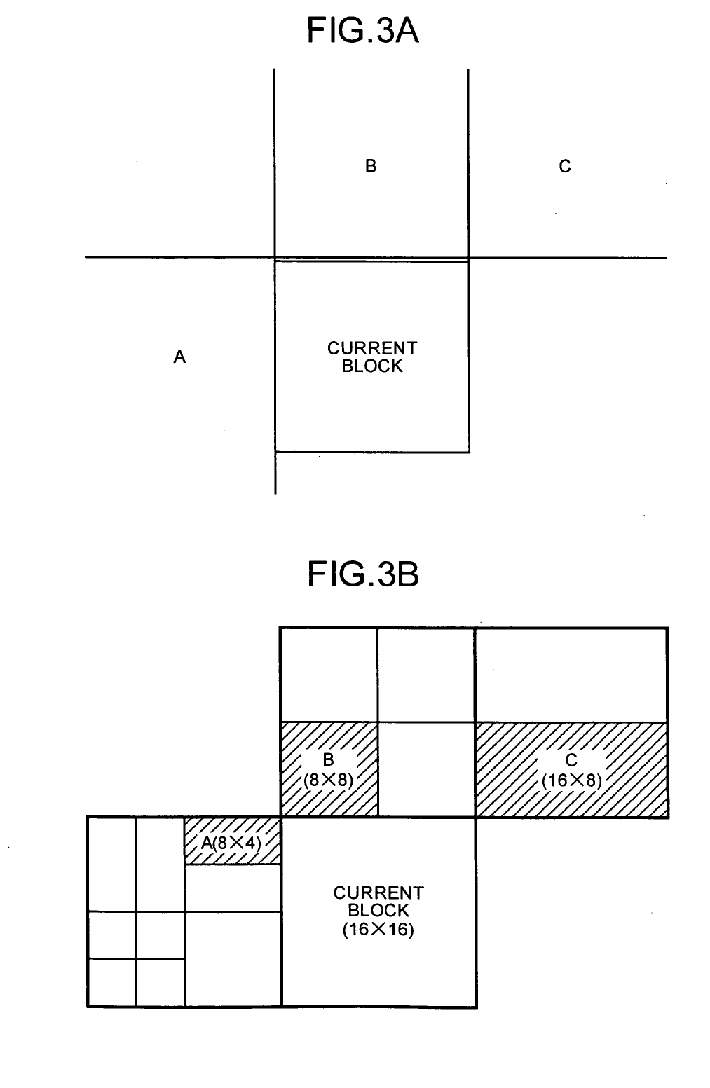

FIGS. 3A and 3B are diagrams for explaining motion vector prediction. To take H.264 as an example, prediction vectors are calculated as a median value of motion vectors of three adjacent coded blocks in a frame.

As shown in FIG. 3A, the prediction vectors are calculated based on motion vectors of a block (current block) to be coded having an upper left top and an upper right top as base points. More specifically, a median value of motion vectors of three blocks, i.e., a left adjacent block A and an upper adjacent block B adjacent to the upper left top of the current block and an upper right adjacent block C adjacent to the upper right top of the current block is calculated. The median value is calculated with respect to horizontal and vertical components. In this manner, the prediction vectors are calculated.

In H.264, as shown in FIG. 3B, a macroblock having 16×16 pixels are divided into a plurality of prediction block shapes and coded. In this case, depending on the block shape of the current block, the shape of an adjacent block, and the like, the prediction vectors are differently calculated. This is because, when the block shape of the current block and the shape of the adjacent block change, the values of the motion vectors of a block to be calculated also changes.

Therefore, when a current block shape is not determined, a prediction motion vector cannot be calculated at high accuracy.

In addition, reference frames can be switched in each 8×8 pixel block according to H.264. The values of the prediction vectors change depending on identification numbers of reference frames in each 8×8 block or coding modes of adjacent macroblocks.

Therefore, when parameters related to the coding modes of all related adjacent blocks are not determined, prediction motion vectors cannot be calculated at high accuracy.

In the moving picture coding apparatus 10 according to the embodiment, the first prediction motion vector calculating unit 101 and the second prediction motion vector calculating unit 112 are independently arranged. The first prediction motion vector calculating unit 101 and the second prediction motion vector calculating unit 112 independently calculate motion vectors. More specifically, the first prediction motion vector calculating unit 101 calculates an approximate first prediction motion vector within an allowable range of the physical necessity of the coding process. The second prediction motion vector calculating unit 112 calculates the second prediction motion vector by a common motion vector prediction method in coding and decoding.

In this manner, when the second prediction motion vector is not calculated by the second prediction motion vector calculating unit 112, the first prediction motion vector calculating unit 101 can independently calculate the first prediction motion vector. More specifically, in the motion vector estimating unit 100, before the second prediction motion vector is calculated by the second prediction motion vector calculating unit 112, a motion vector of a current macroblock can be calculated based on the first prediction motion vector predicted by the first prediction motion vector calculating unit 101.

In this manner, a high degree of freedom can be given to a coding process order while suppressing coding efficiency from being deteriorated. In other words, when the motion vector estimating unit 100 includes the first prediction motion vector calculating unit 101 and the second prediction motion vector calculating unit 112, an optimum motion vector can be always estimated regardless of restriction on implementation of a coding apparatus, coding software, or the like.

As methods of predicting a motion vector by the first prediction motion vector calculating unit 101, the following methods are used.

### EXAMPLE 1

A virtual prediction motion vector is calculated with a supposition that all macroblocks are subjected to inter-frame coding.

### EXAMPLE 2

In addition to Example 1, an optimum motion vector in a specific block shape (for example 16×16) in all macroblocks is used to calculate a virtual prediction motion vector.

### EXAMPLE 3

A motion vector of an immediately previous macroblock or a motion vector of an immediately previous block is set as a virtual prediction motion vector.

### EXAMPLE 4

A first prediction motion vector is set at a fixed value (for example, (0,0)).

According to Example 1, a first prediction motion vector can be calculated independently of a coding mode, such as intra-coding or inter-coding, a macroblock adjacent to a macroblock to be coded. For this reason, an inter-frame prediction process, a mode determining process, and a motion estimating process can be separately performed. Therefore, for example, a intra- or inter-coding mode determining process and the motion estimating process can be performed by pipeline processing. In this manner, the processes can be efficiently performed.

According to Example 2, the first prediction motion vector can be calculated regardless of the block divided shape of the adjacent macroblock. For this reason, a process of determining an optimum block divided shape of each macroblock and a motion estimation process can be separated from each other. Therefore, for example, the block divided shape determining process and the motion estimation process can be performed as pipeline processing. In this manner, processing efficiency can be achieved.

According to Example 3, the first prediction motion vector calculating unit 101 calculates a motion vector of an immediately previous macroblock or a motion vector of an immediately previous block as a first prediction motion vector. For this reason, an amount of process for motion vector prediction performed by the motion vector estimating unit 100 can be made smaller than an amount of process used when a calculated median value of a plurality of motion vectors is calculated as a first prediction motion vector.

According to Example 4, calculation for motion vector prediction is unnecessary. Therefore, an amount of calculation can be more reduced.

Each of the units 102 to 111 which perform processes after the process of the motion vector estimating unit 100 in the moving picture coding apparatus 10 can be provided as a coding information generating unit.

Example 1 to Example 4 can be selected according to restriction on actual implementation. Example 1 to Example 4 can be adaptively selected. The process performed by the first prediction motion vector calculating unit 101 is not limited to the above method. Another method can also be used.

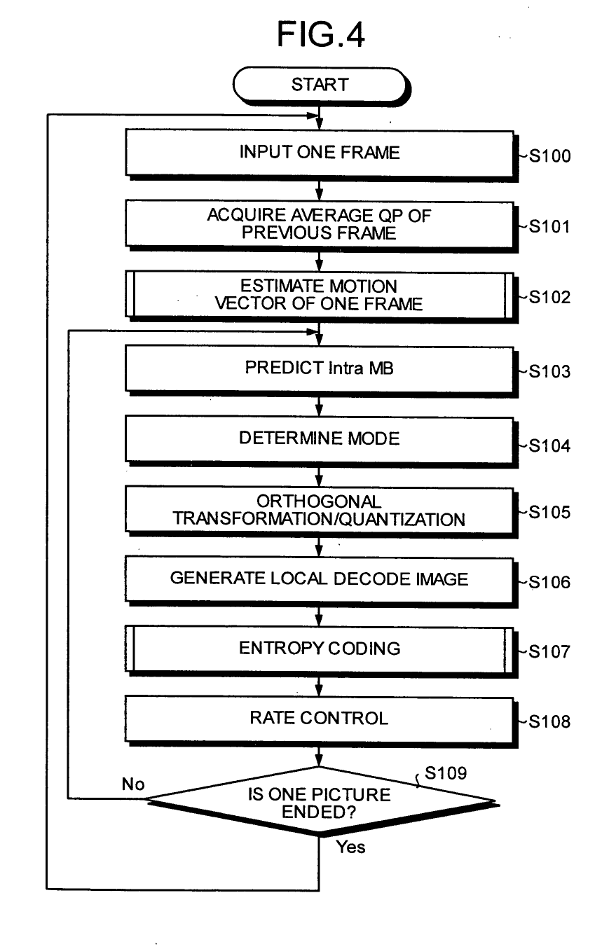

FIG. 4 is a flow chart showing a moving picture coding process in the moving picture coding apparatus 10 according to the first embodiment. One frame of an input moving picture is input to the motion vector estimating unit 100 of the moving picture coding apparatus 10 (step S100). The motion vector estimating unit 100 acquires an average quantization parameter QP of a frame before the target frame (step S101). By using a cost calculated by using the quantization parameter QP is used to estimate motion vectors of all the pixel blocks in the frame (step S102).

Coding processes for the respective macroblocks of one frame are performed. More specifically, the Intra prediction unit 102 performs an intra-frame prediction process to the macroblocks to be coded (step S103). The mode determining unit 104 determines a coding mode (step S104). More specifically, any one of intra-frame coding and inter-frame coding is determined. A prediction mode, a block divided shape, and the like are determined.

The orthogonal transformation unit 105 and the quantization unit 106 perform an orthogonal transformation process and quantization of an orthogonal transformation coefficient to prediction residual signals in the determined coding mode (step S105). The quantized orthogonal transformation coefficients are subjected to inverse quantization and inverse orthogonal transformation and added to prediction signals to generate a local decode image (step S106). The local decode image is then stored in the reference frame memory 110. The entropy coding unit 111 performs entropy coding to the quantized orthogonal transformation coefficients (step S107). A coding result is output.

The rate control unit 113 performs a rate control process to feed back an error between an amount of generated code obtained by entropy coding performed for each macroblock and a target amount of code (step S108). In this manner, a quantization parameter QP of the next macroblock is determined.

The processes in steps S103 to step S108 are sequentially performed to all the macroblocks in the picture (step S109). With this operation ends the coding process of one frame, and coding processes of frames to be sequentially input are sequentially performed in the same manner as described above.

As described above, according to the motion vector estimating unit 100 of the embodiment, by using an average quantization parameter of a coded image, a motion vector or a coding mode for a macroblock to be coded can be determined.

Since the average quantization parameter of the coded image is used to make it possible to calculate a first prediction motion vector, a process such as a motion vector estimating process can be performed by the motion vector estimating unit 100 at a timing before a second prediction motion vector is calculated by the second prediction motion vector calculating unit 112. In this manner, a degree of freedom of a processing order of pipeline processing and the like can be increased.

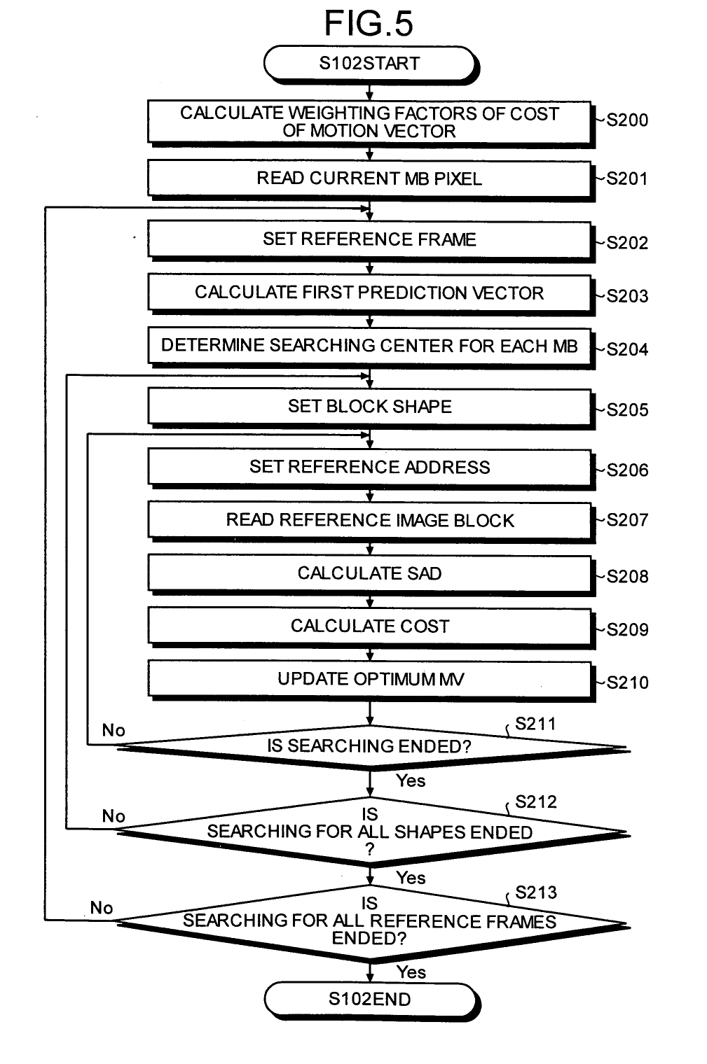

FIG. 5 is a flow chart showing detailed process of the motion vector estimating unit 100 and the first prediction motion vector calculating unit 101 in the motion vector estimating process (step S102) shown in FIG. 4. The motion vector estimating process is a process, which determines an optimum block division shape, optimum reference frame selection of each 8×8 block, and a motion vector of each divided block for each macroblock.

When an average quantization parameter QP of a previous frame is acquired in step S101, the MV/REF cost calculating unit 152 calculates a weighting factor λ of a motion vector cost in the frame according to (Equation 2) (step S200). The calculation of λ may be performed only once for each frame.

The prediction signal generating unit 151 reads each pixel signal of a macroblock to be coded (step S201). The read pixel signals of the macroblock in the frame are then stored in a temporary memory (not shown). When there is a plurality of reference frames, one frame is sequentially set from the plurality of reference frames (step S202).

The first prediction motion vector calculating unit 101 calculates a first prediction motion vector based on the reference frame set for the current macroblock to be coded (step S203). In the calculation of the first prediction motion vector, one of Example 1 to Example 4 is used. The calculation of the prediction motion vector is performed for each macroblock and each reference frame. A common first motion vector is used in a plurality of block shapes. In this manner, an amount of calculation of the first prediction motion vector can be reduced.

The reference address calculating unit 150 determines a center position of motion vector searching (step S204). More specifically, a position indicated by a prediction vector is determined as a searching center position.

As another example, the same positions in the current macroblock and the frame may be determined as searching center positions. Of both the positions in the other example, a position where a prediction error decreases may be determined as a searching center position. As still another example, an input image is analyzed (for example, rough motion estimation) in advance to determine a searching center position.

The reference address calculating unit 150 sets a prediction block shape in a macroblock (step S205). The reference address calculating unit 150 calculates an address to read a reference block within a searching range depending on the reference frame, the searching center, and the block shape which are set by the above processed (step S206).

The prediction signal generating unit 151 reads a reference block signal based on the address calculated by the reference address calculating unit 150 (step S207). The SAD calculating unit 153 calculates a sum of absolute difference SAD between the image signal to be coded read and stored in the temporary memory in step S201 and the reference image signal read in step S207 (step S208).

The coding cost calculating unit 154 calculates a coding cost (step S209). More specifically, a coding cost to code a difference between the first prediction motion vector calculated by the first prediction motion vector calculating unit 101 in step S203 and the motion vector determined by the reference address set by the reference address calculating unit 150 in step S206, a coding cost to code reference frame identification information, a coding cost to code a prediction block shape, and the like are weighting-added to the SAD calculated in step S208 to calculate a coding cost.

The weighting factor λ mentioned here is calculated by using an average quantization parameter QP of an immediately previous frame only once.

The optimum motion vector updating unit 155 uses a motion compensation parameter having the minimum coding cost calculated in step S209 as an optimum motion compensation parameter. More specifically, optimum motion vectors are sequentially updated (step S210).

The above processes are performed to all the combinations of reference pixel blocks in a searching range, all available block divided shapes, and all available reference frames (steps S211 to step S213).

With the above processes, the processes performed by the motion vector estimating unit 100 and the first prediction motion vector calculating unit 101 to determine an optimum motion compensation parameter are completed.

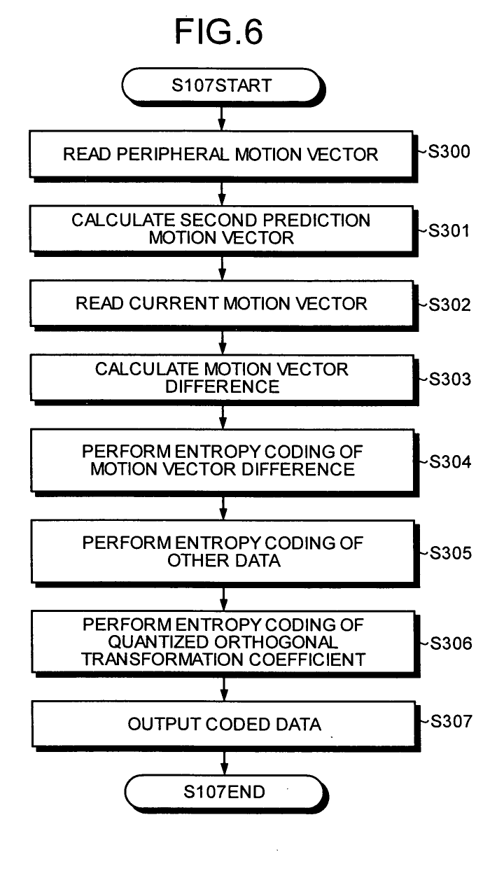

FIG. 6 is a flow chart showing detailed processes of the entropy coding unit 111 and the second prediction motion vector calculating unit 112 in the entropy coding process (step S107) described in FIG. 4. In the entropy coding process, a coding syntax is generated for each macroblock. The respective syntax elements are entropy-coded.

The second prediction motion vector calculating unit 112 reads settled coding parameters such as motion vectors, motion compensation block shapes, and coding modes of a plurality of coded adjacent macroblocks (step S300). On the basis of the coding parameters, a second prediction motion vector is calculated (step S301).

The entropy coding unit 111 reads a motion vector to be coded (step S302). The entropy coding unit 111 calculates a difference between the second prediction motion vector and the motion vector to be coded (step S303). The calculated difference, i.e., a difference vector is entropy-coded (step S304). In addition to the motion vector, information related to the coding parameters is also coded (step S305). The orthogonal transformation coefficients obtained by quantizing the prediction residual signals are sequentially entropy-coded (step S306). These coded data, which are then entropy-coded are sequentially output (step S307).

In this case, a method of calculating a second motion vector in step S301 is common on a coding side and a decoding side. More specifically, even on the decoding side, a prediction vector is calculated. A decoded difference vector and the calculated prediction vector are added to decode a motion vector.

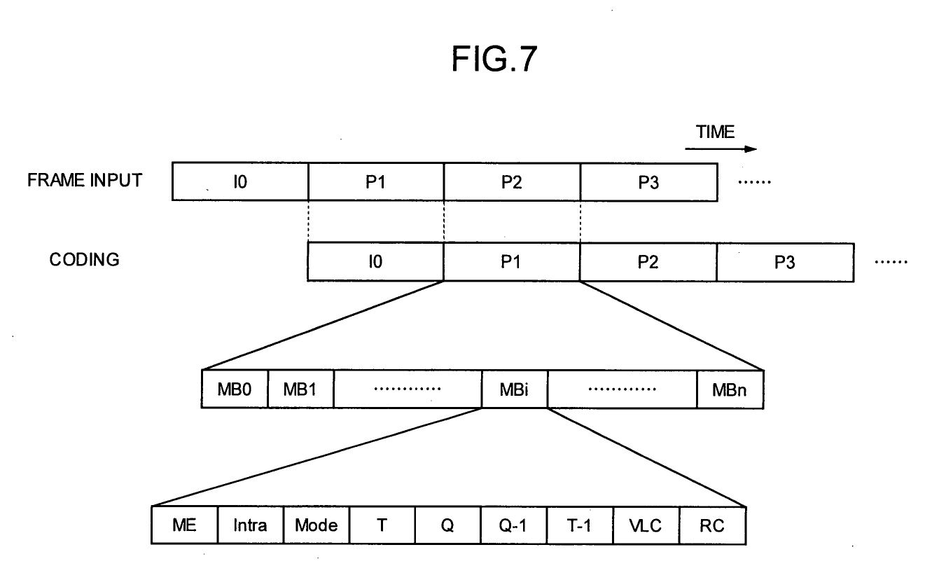

FIG. 7 shows an order of moving picture coding processes in the moving picture coding apparatus 10 according to the embodiment. The abscissa in FIG. 7 denotes time. Symbol “IX (X=0, 1 . . .) denotes an intra-frame coding picture. Symbol “PX” (X=0, 1 . . .) denotes a forward prediction picture. Symbol “BX (X=0, 1 . . .) denotes a bidirectional prediction picture. FIG. 7 shows a manner of inputting an I0 frame, a P1 frame, and a P2 frame in the order named. The moving picture coding apparatus 10 performs a coding process with 1-frame delay.

The coding process is completed in each macroblock in a frame. More specifically, coding processes in a macroblock No. 0 (MB0) to a macroblock No. n (MBn) are sequentially performed. As the processes in the macroblocks, motion estimation (ME), intra-frame prediction (Intra), mode decision (Mode), orthogonal transformation (T), quantization (Q), inverse quantization (Q⁻¹), inverse orthogonal transformation (T⁻¹), entropy coding (VLC), and rate control (RC) are performed in the order named.

The moving picture coding apparatus 10 according to the embodiment completes the coding processes in units of macroblocks in the frame. Therefore, in the coding process to a macroblock to be coded, information of coded macroblocks adjacent to the macroblock to be coded, the quantization parameter QP of the coded macroblock, and the like can be used. Therefore, optimum motion vector estimation, mode decision, and the like using these values can be performed.

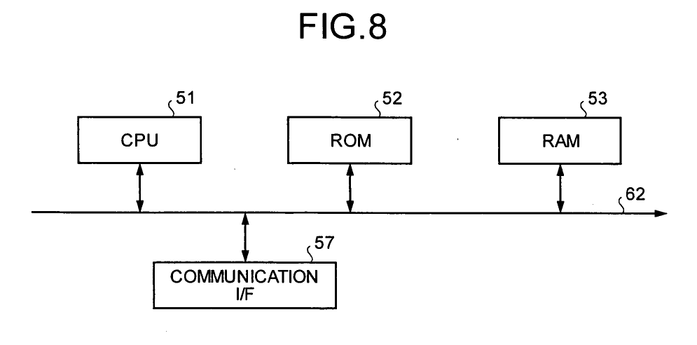

FIG. 8 is a diagram showing the hardware configuration of the moving picture coding apparatus 10 according to the embodiment. The moving picture coding apparatus 10 includes, as hardware configuration, a ROM 52 in which a moving picture coding program or the like for executing a moving picture coding process in the moving picture coding apparatus 10 is stored, a CPU 51 which controls of the units of the moving picture coding apparatus 10 according to the program in the ROM 52, a RAM 53 which stores various data required to control the moving picture coding apparatus 10, a communication I/F 57 which is connected to a network to perform communication, and a bus 62 which connects the respective units to each other.

The moving picture coding program in the moving picture coding apparatus 10 described above may be recorded on a computer readable recording medium such as a CD-ROM, a floppy disk (FD), or a DVD as a file of an installable format or an executable format to provide the moving picture coding program.

In this case, the moving picture coding program is loaded on a main memory device by reading the moving picture coding program from the recording medium and executed in the moving picture coding apparatus 10, so that the units described in the software configuration are formed on the main memory device.

The moving picture coding program according to the embodiment is stored in a computer connected to a network such as the Internet, and the moving picture coding program is downloaded through the network, so that the moving picture coding program may be provided.

Although the invention is described by using the embodiment, the embodiment can be variably changed and modified.

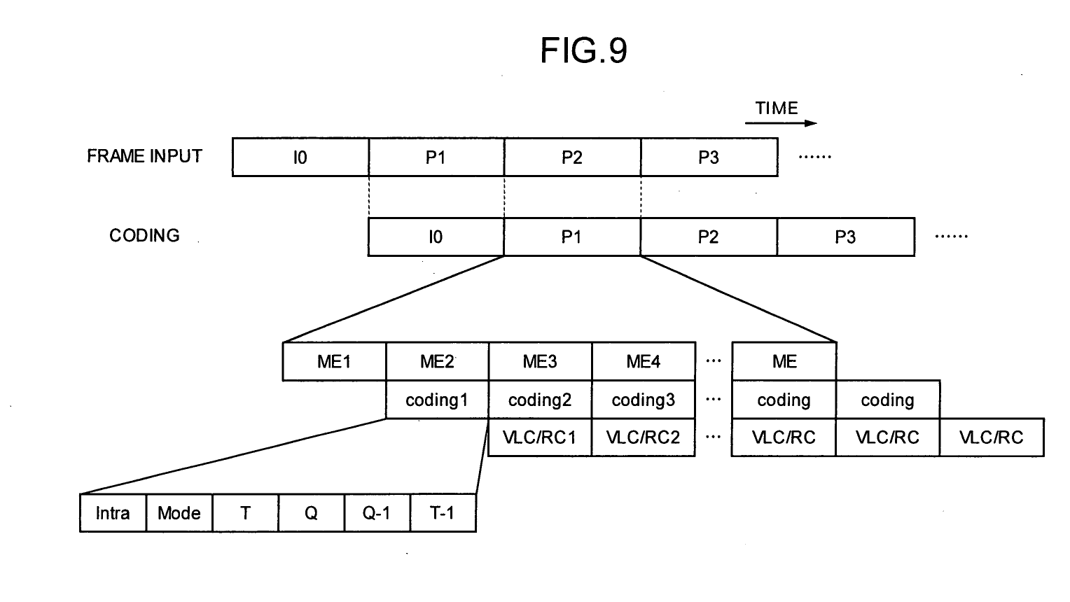

A moving picture coding apparatus 10 according to a second embodiment will be described below. The moving picture coding apparatus 10 according to the second embodiment performs a one-frame coding process by three-stage pipeline processing. FIG. 9 shows an order and timings of processes in the moving picture coding apparatus 10 according to the second embodiment.

The pipeline processing according to the embodiment is divided into three processes, i.e., motion estimation (ME), intra-frame prediction (Intra) to inverse orthogonal transformation (T⁻¹) (coding), and entropy coding (VLC) and rate control (RC). These processes are performed in units of macroblocks.

In the pipeline processing, when the motion estimation (ME1) process is performed, coding 1 and VLC/RC 1 to a corresponding current macroblock are not performed. Therefore, a quantization parameter QP of the current macroblock determined by the rate control (RC) at the end of immediately previous macroblock coding, a coding mode of the immediately previous macroblock determined by the mode decision (Mode), and the like are not fixed.

More specifically, a weighting factor of a coding cost such as a prediction vector or a motion vector based on these pieces of information cannot be accurately calculated.

However, in the moving picture coding apparatus 10 according to the embodiment, the first prediction motion vector calculating unit 101 calculates a first prediction motion vector regardless of a value such as the quantization parameter QP, and the weighting factor of the motion vector or the like can be determined by using the quantization parameter QP or the like of a coded image. In this manner, motion vector estimation can be performed at high accuracy without regard to pipeline delay.

The other configuration and the other processes of the motion vector estimating unit 100 according to the second embodiment are the same as the configuration and the processes of the moving picture coding apparatus 10 according to the first embodiment.

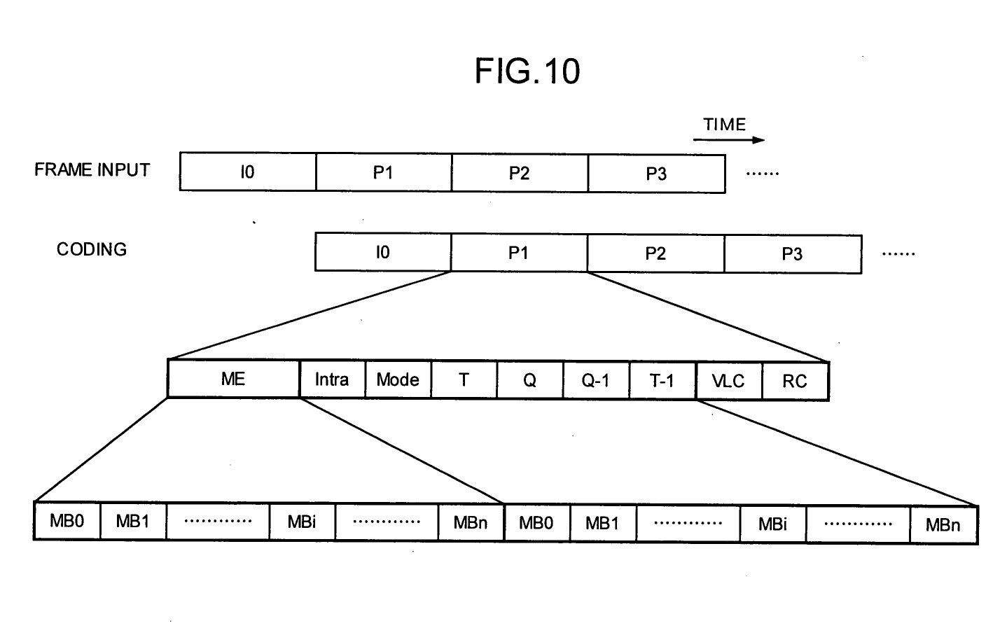

A moving picture coding apparatus 10 according to a third embodiment will be described below. In place of completion of coding processes for macroblocks in frames, the moving picture coding apparatus 10 according to the third embodiment performs a predetermined process to all macroblocks in each frame, and then the moving picture coding apparatus 10 performs the next process to all the macroblocks. FIG. 10 is a chart showing an order of processes and timings of the processes according to the third embodiment.

More specifically, all motion vector estimation (ME) for the respective macroblocks of one frame is performed in advance, and a coding process including the intra-frame prediction (Intra) to the inverse orthogonal transformation (T⁻¹) is performed to all the macroblocks in one frame. Finally, the entropy coding (VLC) and the rate control (RC) are performed to all the macroblocks in one frame.

In this case, as same in the moving picture coding apparatus 10 according to the second embodiment, when the motion vector estimation (ME) is performed, a coding mode (for example, intra-frame coding or inter-frame coding is selected) of an adjacent macroblock, a quantization parameter QP to the macroblock, and the like are not determined. Therefore, the motion vector estimation using the quantization parameter QP and the like cannot be easily performed.

However, as same in the description of the second embodiment, the first prediction motion vector calculating unit 101 of the moving picture coding apparatus 10 can calculate a first prediction motion vector independently of the quantization parameter QP and the like, and weighting factors of coding costs of a motion vector and the like can be determined by using the quantization parameter QP and the like of a coded image. Therefore as shown in FIG. 10, the processes can be performed to all the blocks in the frame at once while performing the motion vector estimation at high accuracy.

When the coding processes are performed in the order and at the timings shown in FIG. 10, instruction codes of the processes need not be frequently called when the coding processes are sequentially performed by a processor or the like, and processing efficiency can be achieved. A hit rate of instruction caches is improved to make it possible to increase a processing speed, and the speed of the coding process can be increased without deteriorating coding efficiency, i.e., without reducing a bandwidth of instruction code loading from an external memory.

The other configuration and the other processes of the motion vector estimating unit 100 according to the third embodiment are the same as the configuration and the processes of the moving picture coding apparatus 10 according to the second embodiment.

A moving picture coding apparatus 10 according to a fourth embodiment will be described below. The moving picture coding apparatus 10 according to the fourth embodiment codes a moving picture by using a bidirectional prediction picture B. The moving picture coding apparatus 10 according to the fourth embodiment performs a coding process by telescopic searching.

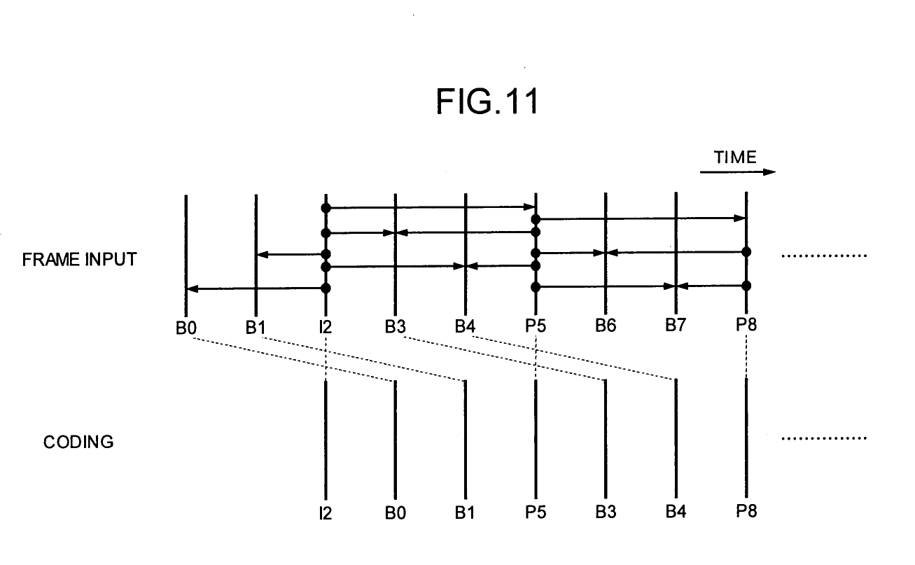

FIG. 11 is a chart showing an order and timings of coding processes of the moving picture coding apparatus 10 according to the fourth embodiment. In intra-frame coding and forward prediction, an immediately previous I frame or an immediately previous P frame are used as reference frames in an order of inputting.

In bidirectional prediction, two frames, i.e., any one frame of the immediately previous I frame and the immediately *previous P frame and any one of frame of an immediately following I frame and an immediately following P frame are used as reference frames.

In FIG. 11, a relation from the reference frame to a frame to be coded is indicated by an arrow. More specifically, the arrow extends from the reference frame to the frame to be coded.

In the B picture, prediction from a future frame is performed. Therefore, as shown in FIG. 11, an input order is different from a coding order.

Inter-frame prediction is performed at intervals of two or more frames. Therefore, in order to follow an inter-frame change, in motion vector searching, motion vector searching must be performed from a wide searching range depending on an inter-frame distance between the reference frame and the frame to be coded. Generally, an amount of calculation of motion vector estimation increases depending on a searching range.

In this case, a telescopic search method may be used to solve the above problem. For example, in FIG. 11, when motion vector estimation is performed at a 3-frame interval by using a P5 frame and an I2 frame as a frame to be coded and a reference frame, a motion vector from the I2 frame to a B3 frame for each macroblock is firstly estimated. A searching center in motion vector searching from the I2 frame to a B4 frame is determined for each macroblock by using a motion vector extending from the I2 frame to the B3 frame. Motion vector searching from the I2 frame to the B4 frame is performed around the searching center.

A searching center of motion vector searching from the I2 frame to the P5 frame is determined for each macroblock by using a motion vector extending from the I2 frame to the B4 frame, searching of the motion vector extending from the I2 frame to the P5 frame is performed around the searching center.

According to the telescopic search, as described above, a motion vector having a large inter-frame distance can also be estimated at high accuracy with a small number of times of searching.

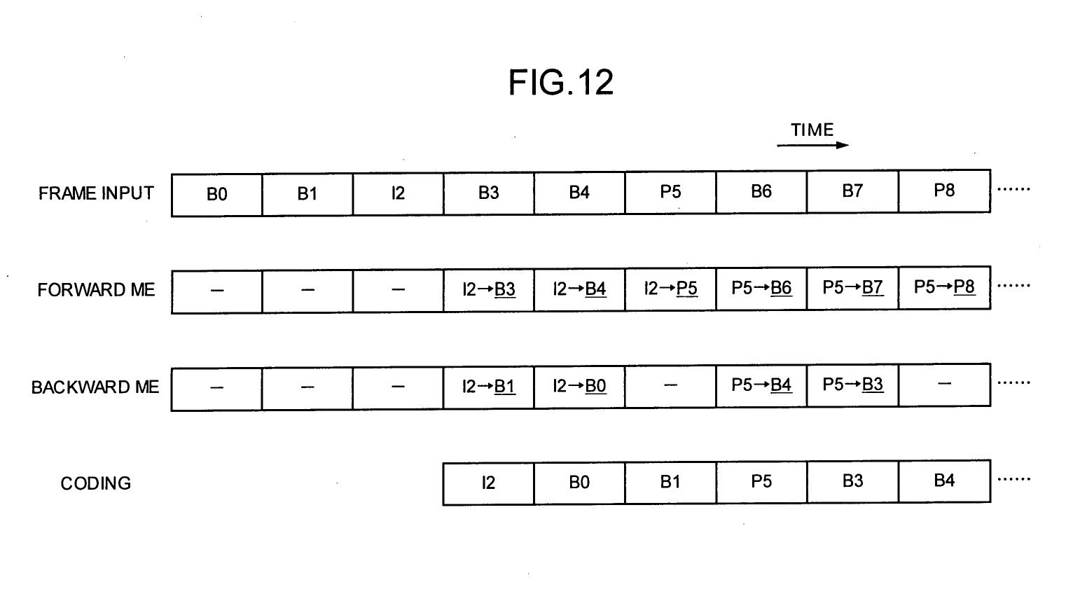

When the telescopic search is performed, the order of motion vector estimation is important as described above. FIG. 12 shows a timing chart related to motion vector estimation in the telescopic search.

In this example, forward motion vector estimation is performed simultaneously with inputting of a frame. More specifically, the moment the B3 frame is input, the motion vector extending from the I2 frame to the B3 frame is estimated for each macroblock.

At an input timing of the B4 frame, a searching center is determined for each macroblock by using the motion vector extending from the I2 frame to the B3 frame, then the motion vector extending from the I2 frame to the B4 frame is estimated.

In addition, at the input timing of the P5 frame, a searching center is determined for each macroblock is by using the motion vector extending from the I2 frame to the B4 frame, then the motion vector extending from the I2 frame to the P5 frame is estimated.

In backward prediction of a bidirectional picture, the motion vector extending from the I2 frame to the B1 frame is estimated for each macroblock at the input timing of the B3 frame. At the input timing of the B4 frame, a searching center is determined for each macroblock by using the motion vector extending from the I2 frame to the B1 frame, then a motion vector extending from the I2 frame to a B0 frame is estimated.

With respect to the I frame and the P frame, the remaining coding process except for the motion vector estimation is performed one frame behind the inputting of the frames. With respect to the B frame, the remaining coding process is performed (frame interval of the I frame or the P frame+1 frame) behind the inputting of the frame.

As described above, when coding with rearrangement of the frames is performed by using telescopic search, motion vector estimation and the remaining coding process are not always performed at the same timing. More specifically, most of motion vector estimation is executed prior to the remaining coding process.

Therefore, in the motion vector estimation, a quantization parameter determined in rate control, a coding mode of an adjacent macroblock, and the like are not fixed. More specifically, motion vector estimation using coding costs calculated based on the quantization parameters and the coding modes cannot be performed.

However, the first prediction motion vector calculating unit 101 of the moving picture coding apparatus 10 according to the embodiment can determine a first prediction motion vector without using the values such as the quantization parameters QP of macroblocks to be coded. Weighting factors of coding costs of motion vectors or the like can be determined by using quantization parameters QP of a coded image.

In this manner, as shown in FIG. 11, even in the telescopic search in which motion vector estimation and a remaining coding process are executed at different timings, the motion vector estimation can be performed at high accuracy.

The other configuration and the other processes of the moving picture coding apparatus 10 according to the fourth embodiment are the same as the configuration and the processes of the moving picture coding apparatus 10 according to the second embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for coding a moving picture, comprising:
a first predicted motion vector storing unit that stores a predetermined first predicted motion vector;
a motion vector generating unit that generates a motion vector based on the first predicted motion vector;
a coding information generating unit that generates coding information used to code a target block, based on the motion vector generated by the motion vector generating unit;
a second predicted motion vector generating unit that generates a second predicted motion vector for the target block; and
a coding unit that codes an image of the target block based on the second predicted motion vector.

2. The apparatus according to claim 1, further comprising a first predicted motion vector generating unit that generates a first predicted motion vector of a first region to be coded based on a motion vector generated for a second region adjacent to the first region, wherein
the first predicted motion vector storing unit stores the first predicted motion vector.

3. The apparatus according to claim 2, wherein the first predicted motion vector generating unit generates the first predicted motion vector based on the motion vector generated by the motion vector generating unit.

4. The apparatus according to claim 2, wherein the first region is a macroblock having a plurality of blocks.

5. The apparatus according to claim 2, wherein the first predicted motion vector generating unit generates the first predicted motion vector for Inter coding.

6. The apparatus according to claim 2, wherein the first predicted motion vector generating unit generates the first predicted motion vector of the first region having a predetermined shape and size.

7. The apparatus according to claim 2, wherein the first predicted motion vector generating unit generates the first predicted motion vector based on a motion vector of a frame previous to a frame including the first region.

8. The apparatus according to claim 2, wherein the motion vector generating unit generates the motion vector of the first region based on quantization parameter of the second region which has been generated and the first predicted motion vector.

9. An apparatus for coding a moving picture, comprising:
a motion vector generating unit that generates a motion vector of a first region to be coded based on quantization parameter which has been generated for a second region having an image adjacent to an image of the first region; and
a coding unit that codes the image of the first region based on the motion vector.

10. The apparatus according to claim 9, wherein the motion vector generating unit generates the motion vector of the first region to be coded based on quantization parameter generated for a third region adjacent to the first region, the third region being in a frame including the first region.

11. The apparatus according to claim 9, wherein the motion vector generating unit generates the motion vector of the first region to be coded based on quantization parameter generated for a third region adjacent to the first region, the third region being in a frame previous to a frame including the first region.

12. The apparatus according to claim 9, wherein the motion vector generating unit generates the motion vector based on quantization parameter generated for a third region in a frame having the same coding mode as that of a frame including the first region.

13. A method for coding a moving picture, comprising:
generating a motion vector based on a first predicted motion vector;
generating coding information used to code a target block, based on the motion vector;
generating a second predicted motion vector for the target block; and
coding an image of the target block based on the second predicted motion vector.

14. A method for coding a moving picture, comprising:
generating a motion vector of a first region to be coded based on quantization parameter which has been generated for a second region having an image adjacent to an image of the first region; and
coding the image of the first region based on the motion vector.

15. A computer program product having a computer readable medium including programmed instructions for coding a moving picture, wherein the instructions, when executed by a computer, cause the computer to perform:
generating a motion vector based on a first predicted motion vector;
generating coding information used to code a target block, based on the motion vector;
generating a second predicted motion vector for the target block; and
coding an image of the target block based on the second predicted motion vector.

16. A computer program product having a computer readable medium including programmed instructions for coding a moving picture, wherein the instructions, when executed by a computer, cause the computer to perform:
generating a motion vector of a first region to be coded based on quantization parameter which has been generated for a second region having an image adjacent to an image of the first region; and
coding the image of the first region based on the motion vector.
